(19) United States
(12) Patent Application Publication
(10) Pub. No.: US 2003/0001892 A1
(43) Pub. Date: Jan. 2, 2003

(54) Property editor graphical user interface apparatus, method and computer program product

(75) Inventors: John Mark Hartel, Austin, TX (US); John Conrad Sanchez, Pflugerville, TX (US); Karalee Brown LeBlanc, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/882,172

(22) Filed: Jun. 14, 2001

(51) Int. Cl. G06F 3/00

(52) U.S. Cl. 345/762

(57) ABSTRACT

An apparatus, method and computer program product for selecting and displaying graphical user interfaces for editing properties are provided. With the apparatus, method and computer program product, metadata associated with a property is analyzed to determine a type of editor associated with the property. This determination may include identifying one or more PropertyEditor Interface methods invoked by the property editor. Based on the type of editor associated with the property, one of a number of predetermined graphical user interfaces is selected. The selected graphical user interface is provided to a user who may use the graphical user interface to thereby edit the property.

### BACKGROUND OF THE INVENTION

1. Technical Field

The present invention is directed to an improved computing device. More specifically, the present invention is directed to a property editor graphical user interface apparatus, method and computer program product.

2. Description of Related Art

In Java, for example, when a programmer is building a property, i.e. a data type, the programmer must also provide an editor for editing that property. The editor may be an editor that makes use of established editing methods supplied by Java or may be, for example, a custom editor having custom methods designated by the programmer. Thus, if a programmer creates three new properties, the programmer must also create three new property editors. For example, if the programmer creates a percentage property, a floating point number property, and a string property, the programmer must generate a property editor having a different graphical user interface for each of these different types of properties. As can be seen, as the number of properties generated increases, the time necessary to create these editors becomes burdensome.

In addition, because there is no standard for providing these property editors, each programmer is free to create his or her own property editor without regard to how another programmer might create the same property editor. That is, one programmer may create a first property editor for a property, the first property editor having a first type of graphical user interface, while a second programmer may create a second property editor for the same or a similar property having a different type of graphical user interface. Because of this, programmers must become accustom to a wide variety of property editors rather than there being a uniform look and feel to the property editors. Thus, the present state of the art does not encourage reuse of property editors and does not provide any standard by which programmers are assured that their property editors may be used by other programmers.

Therefore, it would be beneficial to have an apparatus and method that encourages code reuse with regard to property editors and forces consistency between graphical user interfaces in property editors.

### SUMMARY OF THE INVENTION

The present invention provides an apparatus, method and computer program product for selecting and displaying graphical user interfaces for editing properties. With the present invention, a property editor of a property is analyzed to determine the methods associated with the property editor. Based on the methods associated with the property editor, one of a number of predetermined graphical user interfaces is selected. The selected graphical user interface is provided to a user, such as a programmer, who may use the graphical user interface to thereby edit the property.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram illustrating a network data processing system in accordance with the present invention;

FIG. 2A is an exemplary diagram illustrating a server data processing device in accordance with the present invention;

FIG. 2B is an exemplary diagram illustrating a client data processing device in accordance with the present invention;

FIG. 3 is an exemplary diagram illustrating a Java Virtual Machine in accordance with the present invention;

FIG. 4A is an exemplary diagram illustrating a graphical user interface according to one embodiment of the present invention;

FIGS. 4B and 4C illustrate example implementations of the graphical user interface of FIG. 4A;

FIG. 5A is an exemplary diagram illustrating a graphical user interface according to another embodiment of the present invention;

FIGS. 5B and 5C illustrate example implementations of the graphical user interface of FIG. 5A;

FIG. 6A is an exemplary diagram illustrating a graphical user interface according to yet another embodiment of the present invention;

FIG. 6B illustrates an example implementation of the graphical user interface of FIG. 6A; and

FIG. 7 is a flowchart outlining an exemplary operation of the present invention.

### DETAILED DESCRIPTION OF THE PREFERRED EMBODIMENT

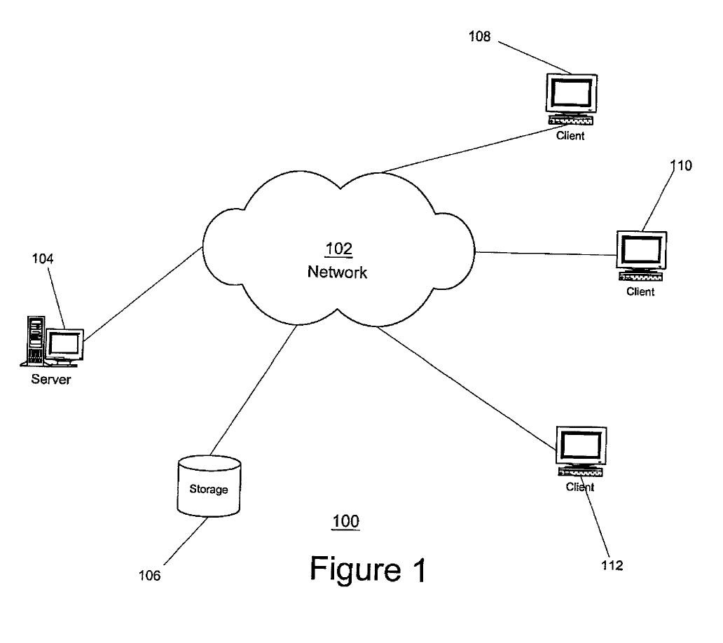

The present invention provides a mechanism by which a graphical user interface is selected for use with a Java property editor based on the type of Java property editor that is to be used in editing a specified Java property. That is, the present invention determines what methods are associated with the Java property editor of a selected Java property to determine how to visually present a graphical user interface to allow editing of the property. The present invention may be implemented in a stand-alone computing device, a client device, a server device, or may be distributed between a client device and a server device. Moreover, the present invention may be implemented in conjunction with a Java Virtual Machine (JVM), a Java editor application or applet, or the like. As such, the following FIGS. 1-3 are intended to provide background as to the environment in which the present invention may be implemented.

With reference now to the figures, and in particular with reference to FIG. 1, a pictorial representation of a distributed data processing system in which the present invention may be implemented is depicted. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections.

In the depicted example, a server 104 is connected to network 102 along with storage unit 106. In addition, clients 108, 110, and 112 also are connected to a network 102. These clients 108, 110, and 112 may be, for example, personal computers or network computers. For purposes of this application, a network computer is any computer, coupled to a network, which receives a program or other application from another computer coupled to the network. In the depicted example, server 104 provides data, such as boot files, operating system images, and applications to clients 108-112. Clients 108, 110, and 112 are clients to server 104. Distributed data processing system 100 may include additional servers, clients, and other devices not shown.

In the depicted example, distributed data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems, that route data and messages. Of course, distributed data processing system 100 also may be implemented as a number of different types of networks, such as, for example, an Intranet or a local area network.

FIG. 1 is intended as an example, and not as an architectural limitation for the processes of the present invention. The present invention may be implemented in the depicted distributed data processing system or modifications thereof as will be readily apparent to those of ordinary skill in the art.

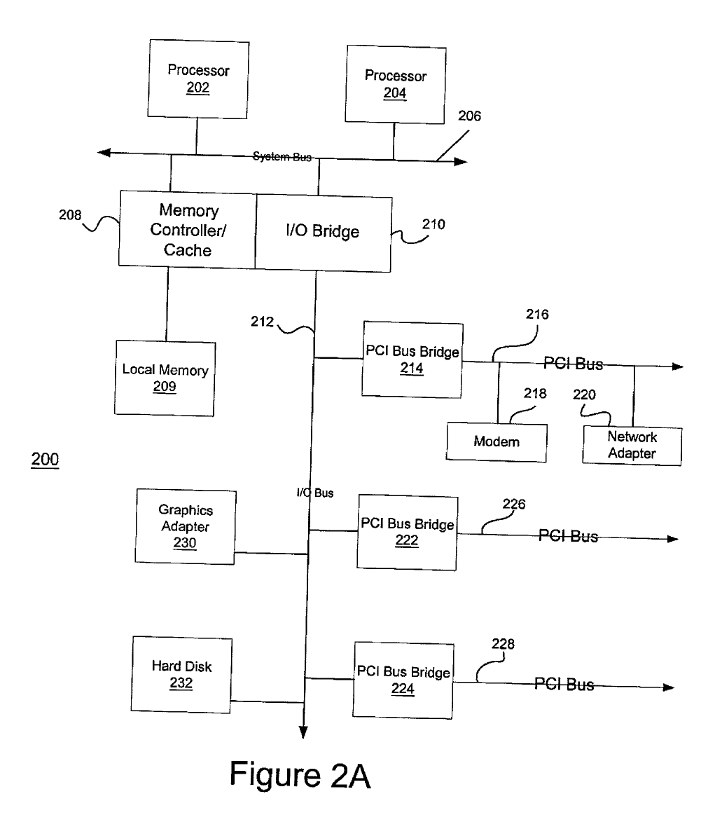

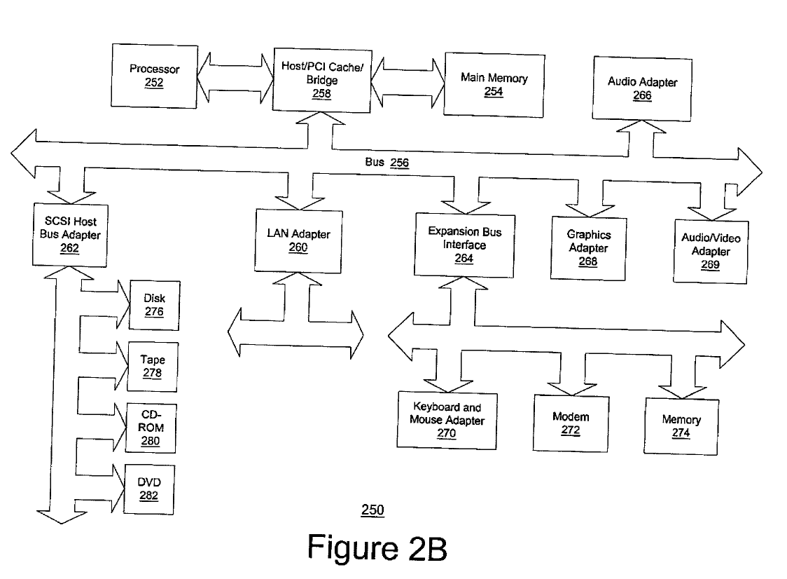

With reference now to FIG. 2A, a block diagram of a data processing system which may be implemented as a server, such as server 104 in FIG. 1, is depicted in accordance to the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A modem 218 may be connected to PCI local bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2A may vary. For example, other peripheral devices, such as optical disk drive and the like also may be used in addition or in place of the hardware depicted. The depicted example is not meant to imply architectural limitations with respect to the present invention.

The data processing system depicted in FIG. 2A may be, for example, an IBM RISC/System 6000 system, a product of International Business Machines Corporation in Armonk, N.Y. running the Advanced Interactive Executive (AIX) operating system.

With reference now to FIG. 2B, a block diagram of a data processing system in which the present invention may be implemented is illustrated. Data processing system 250 is an example of a client computer. Data processing system 250 employs a peripheral component interconnect (PCI) local bus architecture. Although the depicted example employs a PCI bus, other bus architectures such as Micro Channel and ISA may be used. Processor 252 and main memory 254 are connected to PCI local bus 256 through PCI Bridge 258. PCI Bridge 258 also may include an integrated memory controller and cache memory for processor 252. Additional connections to PCI local bus 256 may be made through direct component interconnection or through add-in boards. In the depicted example, local area network (LAN) adapter 260, SCSI host bus adapter 262, and expansion bus interface 264 are connected to PCI local bus 256 by direct component connection. In contrast, audio adapter 266, graphics adapter 268, and audio/video adapter (A/V) 269 are connected to PCI local bus 266 by add-in boards inserted into expansion slots. Expansion bus interface 264 provides a connection for a keyboard and mouse adapter 270, modem 272, and additional memory 274. SCSI host bus adapter 262 provides a connection for hard disk drive 276, tape drive 278, and CD-ROM 280 in the depicted example. Typical PCI local bus implementations will support three or four PCI expansion slots or add-in connectors.

An operating system runs on processor 252 and is used to coordinate and provide control of various components within data processing system 250 in FIG. 2B. The operating system may be a commercially available operating system such as OS/2, which is available from International Business Machines Corporation.

An object oriented programming system such as Java may run in conjunction with the operating system and may provide calls to the operating system from Java programs or applications executing on data processing system 250. Instructions for the operating system, the object-oriented operating system, and applications or programs are located on storage devices, such as hard disk drive 276 and may be loaded into main memory 254 for execution by processor 252. Hard disk drives are often absent and memory is constrained when data processing system 250 is used as a network client.

Those of ordinary skill in the art will appreciate that the hardware in FIG. 2B may vary depending on the implementation. For example, other peripheral devices, such as optical disk drives and the like may be used in addition to or in place of the hardware depicted in FIG. 2B. The depicted example is not meant to imply architectural limitations with respect to the present invention. For example, the processes of the present invention may be applied to a multiprocessor data processing system.

The present invention operates in a Java run-time environment. For example, the present invention may operate in conjunction with a Java Virtual Machine (JVM) yet within the boundaries of a JVM as defined by Java standard specifications. In order to provide a context for the present invention with regard to an exemplary interpretive environment, portions of the operation of a JVM according to Java specifications are herein described.

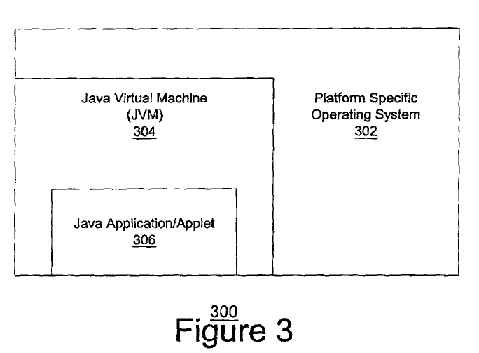

With reference now to FIG. 3, a block diagram illustrates the relationship of software components operating within a computer system that may implement the present invention. Java-based system 300 contains platform specific operating system 302 that provides hardware and system support to software executing on a specific hardware platform. JVM 304 is one software application that may execute in conjunction with the operating system.

Alternatively, JVM 304 may be imbedded inside a Java enabled browser application such as Microsoft Internet Explorer™ or Netscape Communicator™. JVM 304 provides a Java run-time environment with the ability to execute Java application or applet 306, which is a program, servlet, or software component written in the Java programming language. The computer system in which JVM 304 operates may be similar to data processing system 200 or computer 100 described above. However, JVM 304 may be implemented in dedicated hardware on a so-called Java chip, Java-on-silicon, or Java processor with an embedded picoJava core. At the center of a Java run-time environment is the JVM, which supports all aspects of Java's environment, including its architecture, security features, mobility across networks, and platform independence.

The JVM is a virtual computer, i.e. a computer that is specified abstractly. The specification defines certain features that every JVM must implement, with some range of design choices that may depend upon the platform on which the JVM is designed to execute. For example, all JVMs must execute Java bytecodes and may use a range of techniques to execute the instructions represented by the bytecodes. A JVM may be implemented completely in software or somewhat in hardware. This flexibility allows different JVMs to be designed for mainframe computers and PDAs.

The JVM is the name of a virtual computer component that actually executes Java programs. Java programs are not run directly by the central processor but instead by the JVM, which is itself a piece of software running on the processor. The JVM allows Java programs to be executed on a different platform as opposed to only the one platform for which the code was compiled. Java programs are compiled for the JVM. In this manner, Java is able to support applications for many types of data processing systems, which may contain a variety of central processing units and operating systems architectures. To enable a Java application to execute on different types of data processing systems, a compiler typically generates an architecture-neutral file format—the compiled code is executable on many processors, given the presence of the Java run-time system.

The Java compiler generates bytecode instructions that are nonspecific to a particular computer architecture. A bytecode is a machine independent code generated by the Java compiler and executed by a Java interpreter. A Java interpreter is part of the JVM that alternately decodes and interprets a bytecode or bytecodes. These bytecode instructions are designed to be easy to interpret on any computer and easily translated on the fly into native machine code.

A JVM must load class files and execute the bytecodes within them. The JVM contains a class loader, which loads class files from an application and the class files from the Java application programming interfaces (APIs) which are needed by the application. The execution engine that executes the bytecodes may vary across platforms and implementations.

When an application is executed on a JVM that is implemented in software on a platform-specific operating system, a Java application may interact with the host operating system by invoking native methods. A Java method is written in the Java language, compiled to bytecodes, and stored in class files. A native method is written in some other language and compiled to the native machine code of a particular processor. Native methods are stored in a dynamically linked library whose exact form is platform specific.

As mentioned above, the present invention is directed to a mechanism for determine the type of graphical user interface (GUI) to be used with a Java property editor to edit a Java property. A “property” as the term is used herein, refers to anything that can be represented by a Java class, i.e. a data type. Examples of properties include text color, background color, text string, windspeed, percentage, computer operating system, and the like.

Each property has an associated property editor defined by a programmer using one or more methods for displaying and updating property values. These methods may be custom methods created by the programmer or may be methods defined in the Java PropertyEditor interface. The Java PropertyEditor interface defines a plurality of methods that may be used and combined to generate property editors. A table of the methods is provided as Table 1 below.

A Java PropertyEditorManager further defines a plurality of default property editors for various types of properties, such as integer, string, and the like. However, not every property has an associated default property editor. Thus, a user may define a custom property editor for editing a property using custom methods created by the programmer and/or methods provided by the Java PropertyEditor interface. The PropertyEditor Interface and PropertyEditorManager are described in Using Java 1.1, Third Edition, Que Corporation, 1997, pages 824-829, which is hereby incorporated by reference.

With known systems, in order for a user, such as a programmer or the like, to edit a property, the user either designates the property editor that the user wishes to invoke or has a PropertyEditorManager determine the default property editor to invoke. The PropertyEditorManager identifies property editors for properties by performing a string comparison on property editors that are registered with the PropertyEditorManager. That is, a property may have the name Color.class. The corresponding property editor would have the name ColorEditor.class. Thus, by performing a string comparison on the term “color” the correct property editor for the property may be identified.

The present invention provides a standardized graphical user interface (GUI) selection mechanism. The standardized GUI selection mechanism uses the PropertyEditorManager to identify the property editor associated with a selected property. Once the property editor is identified, the property editor is examined to determine which methods in the PropertyEditor Interface are utilized by the property editor. Based on the PropertyEditor Interface methods used by the property editor, one of a plurality of predefined standardized GUIs is selected that can best be used to provided an interface through which the user may edit the property.

TABLE 1
Java PropertyEditor Interface Methods

| Method | Description | Data Type |
|---|---|---|
| AddPropertyChangeListner(listener) | Register a listener for | void |
| | the PropertyChange | |
| | event. | |
| getAsText( ) | Gets the property value | string |
| | as text. | |
| getCustomEditor( ) | A PropertyEditor may | component |
| | choose to make available | |
| | a full customer | |
| | Component that edits its | |
| | property value. | |
| getJavaInitializationString( ) | This method is intended | string |
| | for use when generating | |
| | Java code to set the | |
| | value of the property. | |
| getTags( ) | If the property value | string[ ] |
| | must be one of a set of | |
| | known tagged values, | |
| | them this method should | |
| | return an array of the | |
| | tags. | |
| getValue( ) | Gets the property value. | Object |
| isPaintable( ) | Determines whether this | boolean |
| | property editor is | |
| | paintable. | |
| paingValue(gfx, box) | Paint a representation | void |
| | of the value into a | |
| | given area of screen | |
| | real estate. | |
| removePropertyChangeListener(listener) | Remove a listener for | void |
| | the PropertyChange | |
| | event. | |
| setAsText( ) | Set the property value | void |
| | by parsing a given | |
| | string. | |
| setValue(Object value) | Set (or change) the | void |
| | object that is to be | |
| | edited. | |
| supportsCustomEditor( ) | Determines whether this | boolean |
| | property editor supports | |
| | a customer editor. | |

Thus, with the present invention, the same standardized GUI selection mechanism of the present invention is invoked for every property. Thus, the user need not be familiar with which property editor or the particular graphical user interface for each of the various property editors. In this way, a single “editor” is invoked yet a plurality of different GUIs may be provided.

With the present invention, when a user selects a property that the user wishes to edit, using an interface such as a keyboard, computer mouse, or other pointing device, for example, and selects the standardized GUI selection mechanism of the present invention either before or after selection of the property, the present invention is invoked. Upon receiving the selection of the standardized GUI selection mechanism and the property, the standardized GUI selection mechanism invokes the PropertyEditorManager to determine the property editor associated with the selected property. Once the property editor is identified using the PropertyEditorManager, the standardized GUI selection mechanism examines the methods used by the property editor. Based on the types of methods used by the property editor, one of a plurality of predetermined GUIs is selected for presentation to the user. The selected GUI is the output to a display device using the fields and values identified by the property editor.

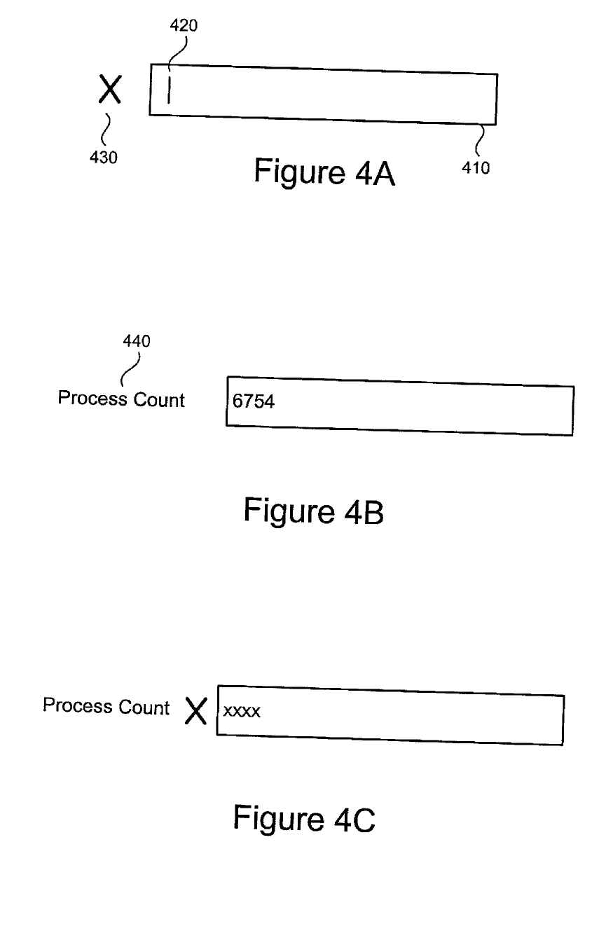

FIG. 4A is an exemplary diagram of a first GUI provided by the present invention for editing a first type of property. When the present invention examines the methods of the selected property editor, if the standardized GUI selection mechanism of the present invention determines that only the getAsText and setAsText methods of the PropertyEditor Interface (see Table 1 above) are implemented by the default property editor for the selected property, the text field entry GUI 400 is presented to the user. This is because the property editor of the selected property is only able to store and retrieve text values for the property.

The text field entry GUI 400 includes a text field entry area 410, a cursor 420, and an entry error indicator 430. The entry error indicator 430 is only visible when there is an entry error in the text field entry area 410. Using the text field entry GUI 400, the user may type a text string and edit a text string using the cursor 420 in the text field entry area 410.

Entries in the text field entry area 410 are set as the value of the property using the setAsText method. If during entry of the text string an invalid entry is identified, the entry error indicator 430 will become visible thereby notifying the user of an invalid entry. An invalid entry is identified by, for example, the setAsText method of the property editor throwing an IllegalArgumentException when the setAsText method attempts to set the new value as the value for the property. The present invention receives and uses this exception as the instigator for displaying the entry error indicator 430.

FIG. 4B illustrates a valid entry in the text field entry area 410. The particular example shown in FIG. 4B is of a property “Process Count” which has a value of integer data type. In the example shown, in addition to the elements 410-430, a property name 440 may also be displayed for informing the user of the property that is being edited.

FIG. 4C illustrates an invalid entry in the text field entry area 410 for a particular property. Again the property is “Process Count” and has a value of integer data type. In the example shown in FIG. 4C, a text string “xxxx” is entered rather than an integer number. Thus, the setAsText method of the property editor for the “Process Count” property throws an IllegalArgumentException indicating that the entry is invalid. As a result, the entry error indicator of the present invention is displayed to thereby inform the user of the invalid entry.

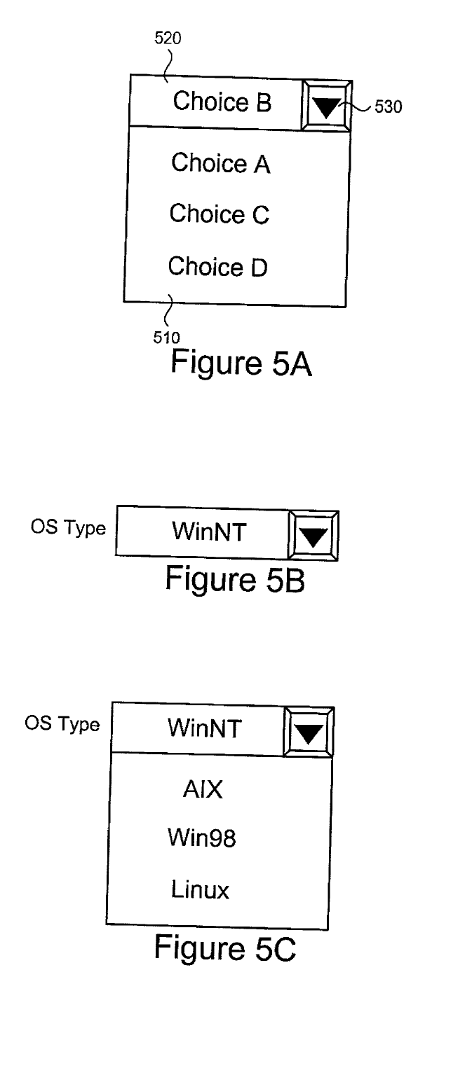

If during examination of the methods used by the property editor the present invention determines that the getTags method of the PropertyEditor Interface is implemented, the property editor is determined to provide a fixed set of values that the property may have. As a result, the present invention displays a GUI as shown in FIG. 5A.

As shown in FIG. 5A, this GUI includes a choice selection area popup 510 which is only visible when the popup virtual button 530 is selected. In addition, the GUI includes a current selection region 520 which displays the current selection from the choice selection area popup 510. It should be noted that this GUI does not include an entry error indicator, such as error entry indicator 430, because there is a predetermined set of possible values for the selected property and the user's selection of a value is limited to one value from this predetermined set. Thus, all possible values must be valid.

FIG. 5B illustrates the GUI of FIG. 5A in which an OS Type is the property and the GUI provides a current selection of “WinNT” in the current selection region 520. As with the GUI 400, the property name may also be displayed in order to inform the user of the property being edited.

When the user selects the popup button 530, the choice selection area popup 510 is displayed providing the user with other possible values for the selected property. In the example shown in FIG. 5C, the other possible choices for OS Type are AIX, Win98 and Linux. The user may select one of these values using a pointing device, one or more keystrokes, or the like. By selecting a new value using the GUI of the present invention, the value for the selected property is reset to the new value using the setAsText method of the PropertyEditor Interface.

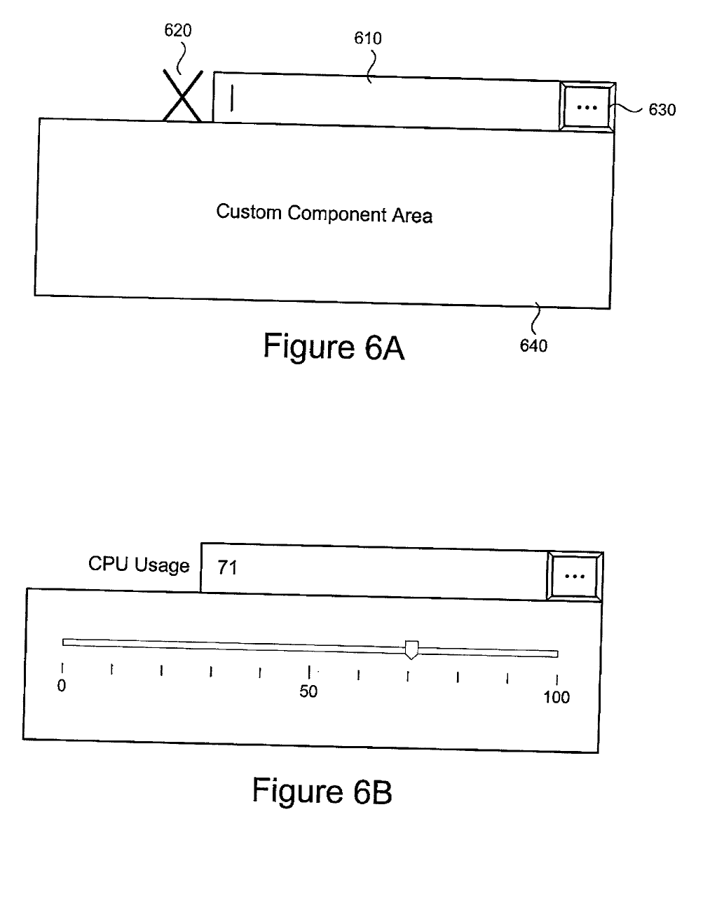

If the present invention determines that the property editor makes use of the supportsCustomerEditor and getCustomerEditor methods of the PropertyEditor Interface, then the selected property editor must be a custom editor. As a result, a different GUI is displayed by the present invention, as shown in FIG. 6A.

As shown in FIG. 6A, the GUI used for custom editors includes a text field entry area 610 and an entry error indicator 620 similar to those in FIG. 4A. In addition, the GUI includes a popup custom component area virtual button 630. The popup custom component area virtual button 630, when selected by a user, causes the custom component popup area 640 to be displayed. The text field entry area 610 operates in the same manner as that shown in FIG. 4A. Through the text field entry area 610, a user may input a value for the selected property. If the entry in the text field entry area 610 is invalid, the entry error indicator 620 will be displayed to inform the user of the invalid entry.

Rather than directly inputting a value for the selected property using the text field entry area 610, the user may make use of the custom editor generated for the selected property by selecting the popup custom component area virtual button 630. In response to selection of the popup custom component area virtual button 630, a custom editor is displayed in the custom component area 640.

FIG. 6B illustrates an example custom editor being displayed in the custom component area 640. In the particular example shown, the property being edited is CPU Usage. The user may edit the value for CPU Usage by using the custom editor, which in this case is a slider bar, to set a new value for the CPU Usage property. The new value for CPU Usage is also displayed in the text field entry area 610. The user may operate the custom editor using any interface means, such as a pointing device, keyboard, or the like. Once the user has selected a new value, the new value is set as the value for the property using the setasText method or any other “backdoor” method provided by the programmer of the custom editor.

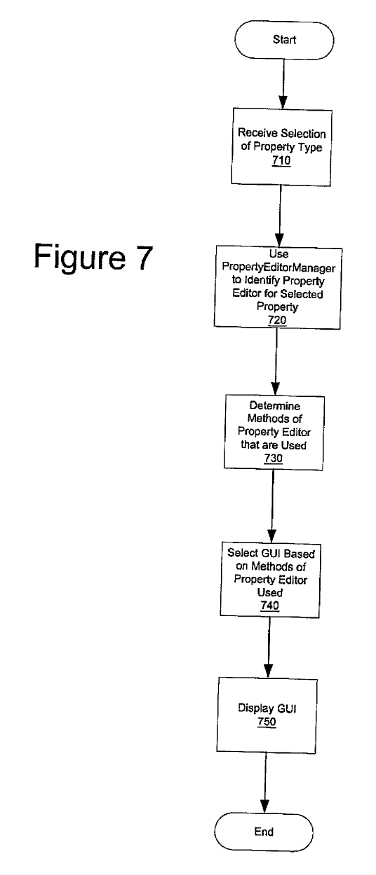

FIG. 7 is a flowchart outlining an exemplary operation of the present invention. As shown in FIG. 7, the operation starts with receiving a selection of a property (step 710). The PropertyEditorManager is then invoked for determining the associated property editor for the selected property (step 720). The property editor is then examined to determine the PropertyEditor Interface methods utilized by the property editor (step 730). Based on the identified methods of the PropertyEditor Interface, a suitable graphical user interface for property editor is selected (step 740). The selected graphical user interface is then output to the user (step 750) who may use the interface to change the value of the selected property in the manner described above.

The following is a listing of pseudo-code for performing the functions of the present invention. While the preferred embodiment makes use of computer implemented instructions for performing the functions of the present invention, one of ordinary skill in the art will appreciate that the functions of the present invention may also be hard coded into hardware that may be used to implement the present invention. Also, a combination of a hardware and software approach may be utilized without departing from the spirit and scope of the present invention. Pseudo-code data flow (Procedures are flagged in italics.)

[image]

[image]

[image]

[image]

[image]

[image]

[image]

Thus, the present invention provides a mechanism by which a single standardized GUI selection mechanism may be invoked for editing all types of properties. The standardized GUI selection mechanism of the present invention examines the methods used by a property editor of a selected property. Based on the types of methods invoked, the present invention provides one of a number of predetermined graphical user interfaces suited for editing of that type of property. Thus, the user need not have an a priori knowledge of each property's editor in order to edit the property.

While the above examples of the preferred embodiments of the present invention illustrate specific examples of graphical user interfaces that are displayed based on information obtained from metadata of selected properties, the present invention is not limited to the particular graphical user interfaces described above. Rather, the present invention is applicable to provide any type of graphical user interface suitable for editing a selected property based on an analysis of metadata for the selected property. Modifications to the graphical user interfaces described above are intended to be within the spirit and scope of the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of editing a property, comprising:
identifying one or more abilities of a property editor;
selecting a graphical user interface based on the one or more abilities of the property editor; and
providing the graphical user interface for use in editing the property.

2. The method of claim 1, wherein the one or more abilities are identified by one or more methods invoked by the property editor.

3. The method of claim 2, wherein the one or more methods invoked by the editor include one or more PropertyEditor Interface methods.

4. The method of claim 1, wherein if the one or more abilities include a text editing ability, the graphical user interface includes a text field entry area.

5. The method of claim 4, wherein if the one or more abilities include a text editing ability, the graphical user interface further includes an entry error indicator.

6. The method of claim 5, wherein the entry error indicator is only visible when an entry in the text field entry area is invalid.

7. The method of claim 1, wherein if the one or more abilities include an ability to edit a property using tags, the graphical user interface includes at least one of a popup choice selection area virtual button and a current selection display field.

8. The method of claim 7, wherein if the popup choice selection area virtual button is selected, a choice selection area popup is presented.

9. The method of claim 1, wherein if the one or more abilities includes an ability to edit the property using a custom editor interface, the graphical user interface includes a popup custom component area virtual button.

10. The method of claim 9, wherein if the one or more abilities includes an ability to edit the property using a custom editor interface, the graphical user interface further includes at least one of a text entry field and an entry error indicator.

11. The method of claim 10, wherein the entry error indicator is only displayed when an invalid entry is entered in the text field entry area.

12. The method of claim 9, wherein a custom component area is presented in response to selection of the popup custom component area virtual button, and wherein the custom component area includes a custom editor for the property.

13. An apparatus for editing a property, comprising:
means for identifying one or more abilities of a property editor;
means for selecting a graphical user interface based on the one or more abilities of the property editor; and
means for providing the graphical user interface for use in editing the property.

14. The apparatus of claim 13, wherein the means for identifying one or more abilities identifies the one or more abilities by one or more methods invoked by the property editor.

15. The apparatus of claim 14, wherein the one or more methods invoked by the editor include one or more PropertyEditor Interface methods.

16. The apparatus of claim 13, wherein if the one or more abilities include a text editing ability, the graphical user interface includes a text field entry area.

17. The apparatus of claim 16, wherein if the one or more abilities include a text editing ability, the graphical user interface further includes an entry error indicator.

18. The apparatus of claim 17, wherein the entry error indicator is only visible when an entry in the text field entry area is invalid.

19. The apparatus of claim 13, wherein if the one or more abilities include an ability to edit a property using tags, the graphical user interface includes at least one of a popup choice selection area virtual button and a current selection display field.

20. The apparatus of claim 19, wherein if the popup choice selection area virtual button is selected, a choice selection area popup is presented.

21. The apparatus of claim 13, wherein if the one or more abilities includes an ability to edit the property using a custom editor interface, the graphical user interface includes a popup custom component area virtual button.

22. The apparatus of claim 21, wherein if the one or more abilities includes an ability to edit the property using a custom editor interface, the graphical user interface further includes at least one of a text entry field and an entry error indicator.

23. The apparatus of claim 22, wherein the entry error indicator is only displayed when an invalid entry is entered in the text field entry area.

24. The apparatus of claim 21, further comprising means for presenting a custom component area in response to selection of the popup custom component area virtual button, wherein the custom component area includes a custom editor for the property.

25. A computer program product in a computer readable medium for editing a property, comprising:
first instructions for identifying one or more abilities of a property editor;
second instructions for selecting a graphical user interface based on the one or more abilities of the property editor; and
third instructions for providing the graphical user interface for use in editing the property.

26. The computer program product of claim 25, wherein the first instructions for identifying one or more abilities includes instructions for identifying one or more methods invoked by the property editor.

27. The computer program product of claim 26, wherein the one or more methods invoked by the editor include one or more PropertyEditor Interface methods.

28. The computer program product of claim 25, wherein if the one or more abilities include a text editing ability, the graphical user interface includes a text field entry area.

29. The computer program product of claim 28, wherein if the one or more abilities include a text editing ability, the graphical user interface further includes an entry error indicator.

30. The computer program product of claim 29, wherein the entry error indicator is only visible when an entry in the text field entry area is invalid.

31. The computer program product of claim 25, wherein if the one or more abilities include an ability to edit a property using tags, the graphical user interface includes at least one of a popup choice selection area virtual button and a current selection display field.

32. The computer program product of claim 31, wherein if the popup choice selection area virtual button is selected, a choice selection area popup is presented.

33. The computer program product of claim 25, wherein if the one or more abilities includes an ability to edit the property using a custom editor interface, the graphical user interface includes a popup custom component area virtual button.

34. The computer program product of claim 33, wherein if the one or more abilities includes an ability to edit the property using a custom editor interface, the graphical user interface further includes at least one of a text entry field and an entry error indicator.

35. The computer program product of claim 34, wherein the entry error indicator is only displayed when an invalid entry is entered in the text field entry area.

36. The computer program product of claim 33, further comprising fourth instructions for presenting a custom component area in response to selection of the popup custom component area virtual button, wherein the custom component area includes a custom editor for the property.

37. A method of editing a property, comprising:
identifying one or more methods invoked by a property editor for the property;
selecting a graphical user interface based on the one or more methods invoked by the property editor;
providing the graphical user interface for use in editing the property.

38. The method of claim 1, wherein the one or more methods invoked by the editor include one or more PropertyEditor Interface methods.

39. The method of claim 1, wherein if the one or more methods includes at least one of a getAsText method and a setAsText method, the graphical user interface includes a text field entry area and an entry error indicator.

40. The method of claim 1, wherein if the one or more methods include a getTags method, the graphical user interface includes a popup choice selection area virtual button and a current selection display field.

41. The method of claim 1, wherein if the one or more methods includes at least one of a supportsCustomEditor method and a getCustomEditor method, the graphical user interface includes a popup custom component area virtual button.
